(19) United States
(12) Patent Application Publication
(10) Pub. No.: US 2026/0160696 A1
(43) Pub. Date: Jun. 11, 2026

(54) Substrate Composition for Raman Spectroscopy

(71) Applicant: Arizona Board of Regents acting for and on behalf of Northern Arizona University, Flagstaff, AZ (US)

(72) Inventors: Miguel Jose Yacaman, Flagstaff, AZ (US); J. Jesus Velazquez-Salazar, Flagstaff, AZ (US); Alondra Hernandez-Cedillo, Flagstaff, AZ (US); Javier Mendez-Lozoya, Flagstaff, AZ (US)

(73) Assignee: Arizona Board of Regents acting for and on behalf of Northern Arizona University, Flagstaff, AZ (US)

(21) Appl. No.: 19/416,865

(22) Filed: Dec. 11, 2025

Related U.S. Application Data
(60) Provisional application No. 63/730,891, filed on Dec. 11, 2024.

(51) Int. Cl. G01N 21/65; B82Y 15/00; B82Y 40/00

(52) U.S. Cl. CPC G01N 21/658; B82Y 15/00; B82Y 40/00

(57) ABSTRACT

Implementations of a substrate for use in Raman spectroscopy may include a first largest planar surface separated from a second largest planar surface by a thickness, the thickness including a plastic material; a layer of aluminum coupled on the first largest planar surface; one or more first defined regions of silver/nickel/nickel oxide nanowires coupled to the layer of aluminum; one or more second defined regions of gold/copper and gold nanostars coupled to the layer of aluminum; and one or more third defined regions of silver/zinc oxide nanostructures coupled to the layer of aluminum.

### CROSS REFERENCE TO RELATED APPLICATIONS

This document claims the benefit of the filing date of U.S. Provisional Patent Application 63/730,891, entitled “Substrate Composition for Raman Spectroscopy” to Yacaman et al. which was filed on Dec. 11, 2024, the disclosure of which is hereby incorporated entirely herein by reference.

### BACKGROUND

### 1. Technical Field

Aspects of this document relate generally to spectroscopic systems and methods, such as systems for conducting Raman spectroscopy.

### 2. Background

Spectroscopic methods are used to determine what is in a sample. Organic chemicals, inorganic compounds, or combinations of the two can be detected using various spectroscopic methods. Many spectroscopic methods utilize observing the behavior of the sample material under various testing conditions.

### SUMMARY

Implementations of a substrate for use in Raman spectroscopy may include a first largest planar surface separated from a second largest planar surface by a thickness, the thickness including a plastic material; a layer of aluminum coupled on the first largest planar surface; one or more first defined regions of silver/nickel/nickel oxide nanowires coupled to the layer of aluminum; one or more second defined regions of gold/copper and gold nanostars coupled to the layer of aluminum; and one or more third defined regions of silver/zinc oxide nanostructures coupled to the layer of aluminum.

Implementations of a substrate for use on Raman spectroscopy may include one, all, or any of the following:

The one or more first defined regions, one or more second defined regions, and one or more third defined regions may be physically separate from each other on the layer of aluminum.

The one or more first defined regions, one or more second defined regions, and one or more third defined regions may contact one another along a perimeter of each region.

The silver/nickel/nickel oxide nanowires and the silver/zinc oxide nanostructures may support surface plasmon polariton excitation that produces Raman signal enhancement of 10⁶-10⁸ times.

The silver/zinc oxide nanostructures and the silver/nickel/nickel oxide nanowires may induce chemical enhancement that produces Raman signal enhancement of 10² times.

The silver/nickel/nickel oxide nanowires may induce magnetoplasmonic enhancement that produces Raman signal enhancement of 10²-10³ times.

The gold/copper and gold nanostars may support localized surface plasmon resonance that produces Raman signal enhancement of 10⁶-10⁸ times.

The substrate may provide surface-enhanced Raman scattering enhancement of 10¹²-10¹⁴ times and surface enhanced infrared absorption spectroscopy enhancement of 10¹²-10^{14.}

The substrate may have surface-enhanced Raman scattering detection of up to 10⁻¹⁴ molar and surface enhanced infrared absorption spectroscopy detection of up to 10⁻¹⁴ molar.

The one or more first defined regions, one or more second defined regions, and one or more third defined regions may be each mechanical abrasion resistant.

The one or more first defined regions, one or more second defined regions, and one or more third defined regions may be configured to receive a sample thereon.

The substrate may be corrosion resistant with a shelf life of up to two years.

The substrate may be corrosion resistant with a shelf life of two years or greater.

The nickel and nickel oxide may prevent corrosion of the silver/nickel/nickel oxide nanowires.

The zinc oxide may prevent corrosion of the silver/zinc oxide nanostructures.

Implementations of a method of forming a substrate for use in Raman spectroscopy may include providing a plastic substrate with a first largest planar surface; forming a layer of aluminum on the first largest planar surface; forming a first patterned layer on the layer of aluminum; applying silver/nickel/nickel oxide nanowires to one or more exposed portions of the layer of aluminum to form one or more defined first regions; and removing the first patterned layer. The method may include forming a second patterned layer on the layer of aluminum; applying gold/copper and gold nanostars to one or more exposed portions of the layer of aluminum to form one or more defined second regions; removing the second patterned layer; forming a third patterned layer on the layer of aluminum; and applying silver/zinc oxide nanostructures to one or more exposed portions of the layer of aluminum to form one or more defined third regions.

Implementations of a method of forming a substrate for use in Raman spectroscopy may include one, all, or any of the following:

The one or more first defined regions, one or more second defined regions, and one or more third defined regions may contact one another along a perimeter of each region.

The method may include preventing corrosion of the silver/nickel/nickel oxide nanowires through applying nickel to silver nanowires and allowing native nickel oxide to form.

The method may include preventing corrosion of the silver/zinc oxide nanostructures through forming zinc oxide on silver nanowires.

The method may include altering a star shape of the gold/copper nanostars through altering a composition of copper included in the gold/copper nanostars.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a scanning electron microscope (SEM) image of a plurality of silver nanowires and a close up SEM image of an end of a single silver nanowire;

FIG. 2 is a top down view of a first implementation of a plurality of silver/nickel/nickel oxide nanowires attached to an aluminum layer coupled to a plastic substrate;

FIG. 3 is a top down view of a second implementation of a plurality of silver/nickel/nickel oxide nanowires attached to an aluminum layer coupled to a plastic substrate;

FIG. 4 is a plot of the electric field norm/along a length of an implementation of a silver/nickel/nickel oxide nanowire viewing the nanowire along its longest dimension;

FIG. 5 is a plot of the electric field norm along a length of the silver/nickel/nickel oxide nanowire implementation of FIG. 4 viewing the nanowire in an end-on view;

FIG. 6 is a plot of the electric field norm of a random configuration of silver/nickel/nickel oxide nanowires;

FIG. 7 is a graph of the electric field norm/versus the silver nanowire radius;

FIG. 8 is a graph of the electric field norm/versus the length of the silver nanowire;

FIG. 9 is a graph of the electric field norm/versus the thickness of the nickel film on the silver nanowires;

FIG. 10 is four SEM images of implementations of silver/zinc oxide nanostructures showing the shapes of the zinc oxide platelets that frow on the faces of the silver nanowire and a view of the as-deposited silver/zinc oxide nanostructures deposited on a substrate;

FIG. 11 is six images of the response of silver/zinc oxide nanorods simulated at frequencies of 10 THz, 30 THz, 60 THz, 150 THz, 200 THz, and 240 THz;

FIG. 12 are various SEM images of implementations of gold and gold/copper nanostars with an image of nanostars applied to a substrate;

FIG. 13 is a top down view illustrating a diagram of an implementations of a substrate for use in Raman spectroscopy showing three regions containing silver/nickel/nickel oxide nanowires, three regions containing silver/zinc oxide nanowires, and three regions containing gold and gold/copper nanostars;

FIG. 14 is a graph showing the surface-enhanced Raman scattering enhancement (SERS) spectra showing the intensity and Raman shift at four different sample concentrations on a substrate implementation;

FIG. 15 is a graph showing the SERS spectra on a substrate implementation at a sample concentration of 10⁻⁴ molar;

FIG. 16 is a diagram of an implementation of a vial containing precursor solution during microwave irradiation to form silver/zinc oxide nanostructures;

FIG. 17 is a graph of the thermal ramp for the different stages of a process for forming silver/zinc oxide nanostructures; and

FIG. 18 is a set of SEM images showing the variation of the epitaxial distribution of zinc oxide nanorods as they form along the length of silver nanowires at different points in time during the reaction.

### DESCRIPTION

This disclosure, its aspects and implementations, are not limited to the specific components, assembly procedures or method elements disclosed herein. Many additional components, assembly procedures and/or method elements known in the art consistent with the intended substrates for use in Raman spectroscopy will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such substrates for use in Raman spectroscopy, and implementing components and methods, consistent with the intended operation and methods.

Raman spectroscopy is one of the most powerful analytical tools for molecular identification, collecting what is a unique vibrational “fingerprint” for each substance being examined. It is widely used in forensics, quality control, homeland security, and biomedical analysis. However, Raman scattering is intrinsically weak—only about one in 20 million photons undergoes inelastic scattering during the procedure, requiring relatively large analyte concentrations for detection. In many defense and biomedical applications, analyte quantities are extremely small and below an amount that Raman spectroscopy can successfully detect (Raman detection limit).

Surface-Enhanced Raman Spectroscopy (SERS) addresses this challenge by amplifying Raman signals by several orders of magnitude by utilizing a substrate on which the sample is placed. Most of SERS substrates are made of nanostructures with plasmonic properties. Despite its potential, SERS has challenges that affect its reliability. The same analyte can yield different spectra on different substrates or on similar substrates that come from different fabrication batches. The observed variation is mostly due to the inherent complexity of synthesis at the nanometer level which magnify entropic effects. In addition, SERS needs direct contact of the analyte with the substrate nanostructure for the amplification effect to work. In many cases, analytes do not actually adhere to the nanostructure or attach to substrate regions that lack nanostructures (empty regions) resulting in a poor detection limit. In addition, the Raman spectra of samples that contain several compounds have overlapping peaks confusing the peak analysis which seeks to deconvolute the various peaks of one compound from one another.

Due to these challenges with SERS, widespread commercialization has not yet taken place, especially in areas in which false negatives can result in severe consequences. For example, SERS can be used to detect cancer biomarkers; more than 10,000 papers to date have reported SERS-based cancer detection in the past decade, showing the possibility of developing early cancer detection tests. However, no SERS-based diagnostic test for cancer is yet commercially available.

For the Surface-Enhanced Raman Scattering (SERS) method to work effectively, the Raman signal needs to be significantly amplified. Theoretically, SERS is so powerful that eventually single molecules on a substrate can be detected through a corresponding Raman spectrum. SERS has many potential applications in fields such as, by non-limiting example, homeland security, environmental testing, virus and bacteria detection, food industry monitoring, and many others. To obtain Raman spectra via SERS, the molecules to be analyzed need to be deposited on a substrate and then irradiated and observed to obtain the Raman signal. The Raman signal amplification which is needed for SERS to be practically useful is between about 10⁶-10¹² times. The same weak single issue exists with infrared spectroscopy (FTIR) which is complementary to Raman spectroscopy but where infrared light is used to illuminate the sample. To enhance the corresponding signal, a technique called Surface Enhanced Infrared absorption spectroscopy (SEIRA) is used.

Achieving consistent SERS performance requires improving several longstanding technical challenges, the first being reproducible nanostructure synthesis. This can be accomplished by minimizing between/within-batch variations in size, composition, and morphology of nanostructures to ensure uniform electromagnetic enhancement. Another challenge is that of efficient analyte attachment to the nanostructures. In some substrate implementations, promoting >95% molecular adsorption to the nanostructured surface is used to reach high sensitivity. Another challenge is creating a substrate with broad plasmonic response capable of enabling amplification for a wide variety of sample types.: Homeland security can utilize detection of low-molecular-weight explosives, biological warfare agents (viruses, bacteria, fungi), and airborne toxins. Distinct resonance conditions for varied sample type demand multi-band plasmonic activity spanning the visible to mid-infrared light. Another challenge is complex sample environments—samples contain interferents that can mask target spectra. Many critical biomolecules (lipids, proteins, and nucleic acids) absorb strongly in the IR; therefore, pairing SERS with Surface-Enhanced Infrared Absorption (SEIRA) can assist with essential for selectivity and cross-validation.

The substrate implementations and related methods disclosed herein describe the fabrication of a substrate for SERS and SEIRA that meets key technical measures for advancing these spectroscopies to the point of development of commercial products based on those techniques. Given that the industry produces very high-quality spectrometers for detecting Raman signals already, most of the technical challenges relate to the substrates/coupons used in the detection process. Fabrication of reliable substrates that permits accurate and repeatable results can open the use of Raman spectroscopy in field in which its application has been limited.

The present disclosure describes a substrate/microchip that contains unique combined substrate of silver nanowires (AgNWs) coated with nickel and nickel oxide (NiO), with silver/zinc oxide (Ag—ZnO) nanostructures and gold/copper and/or gold (Au/Cu and Au) nanostars. This substrate produces a unique combination of physics phenomena that lead to the enhancement of the Raman signal. The substrates disclosed herein may provide various enhancement factors, providing stability, reproducibility, and low detection limits which open the possibility of an application of Raman spectroscopy to many fields in which no commercial applications are available. In addition, the same substrate is also useful in SEIRA. The versatility of the substrate is a part of what makes it unique.

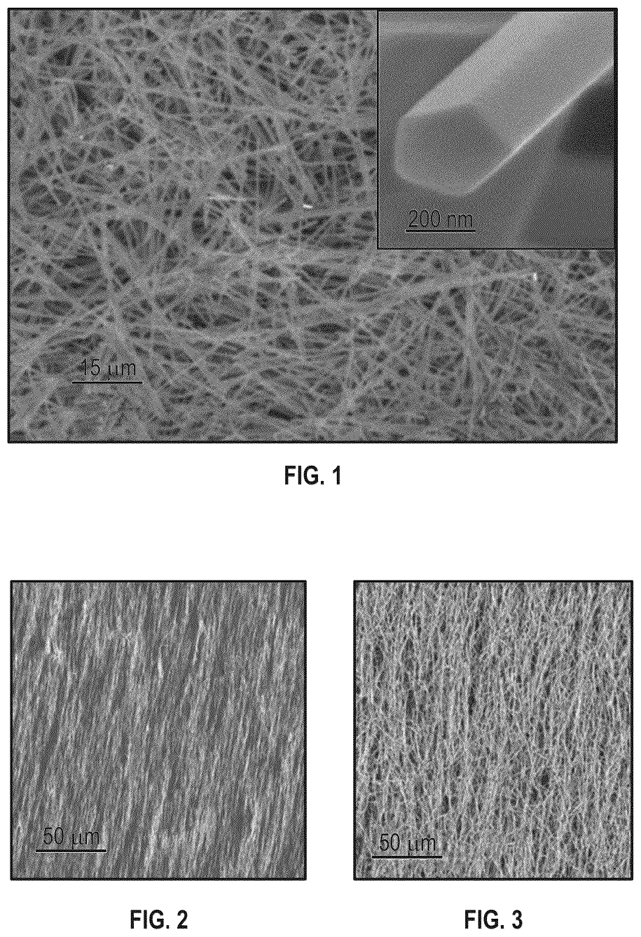

FIG. 1 depicts scanning electron microscope (SEM) images of an assembly of Ag/Ni/NiO nanowires (NWs). The high magnification inset image shows the pentagonal symmetry of the nanowires formed by the crystalline structure of the silver. Over the crystalline structure of the silver a layer of nickel is chemically deposited. After formation of the layer of nickel, a layer of nickel oxide is natively formed through reaction with oxygen in the atmosphere. This layer of nickel oxide serves to passivate the surface of the nanowires/nanorods. Referring to FIG. 2, the silver/nickel/nickel oxide nanowires are illustrated attached to a layer of aluminum applied over a largest planar surface of a plastic substrate support. Referring to FIG. 3, another implementation of silver/nickel/nickel oxide nanowires are illustrated coupled over an aluminum layer attached to a largest planar surface of a plastic substrate support. The difference in alignment of the nanowires is the result of treating the nanowires with a magnetic field during the deposition/application process. Since these nanowires are magnetic, a differently aligned/different strength of magnetic field has the effect of aligning the nanowires in a desired orientation. In this way the ability of the nanowires to amplify the Raman signal can be adjusted using application of different magnetic fields during the formation process.

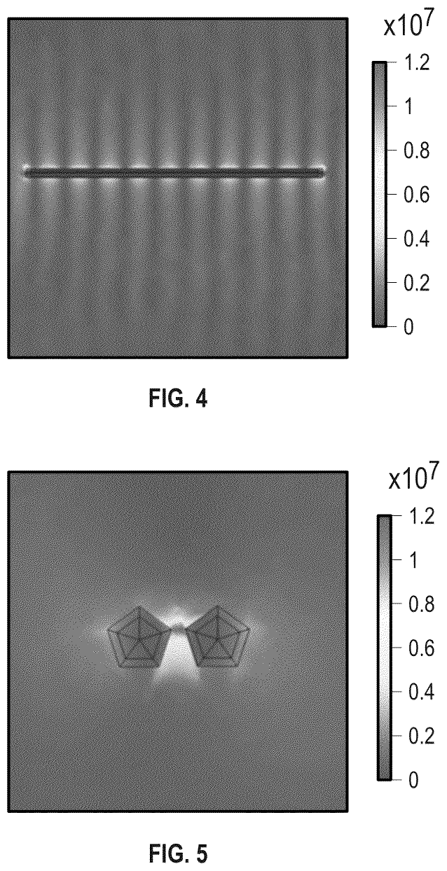

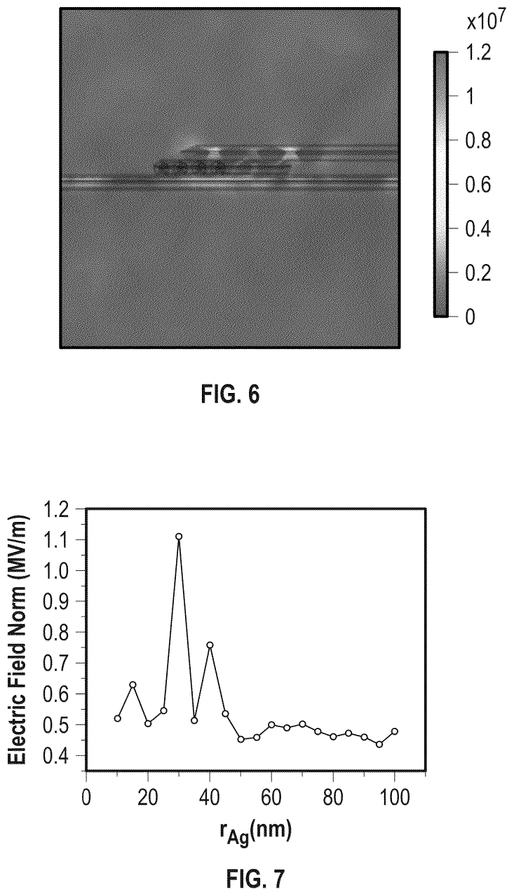

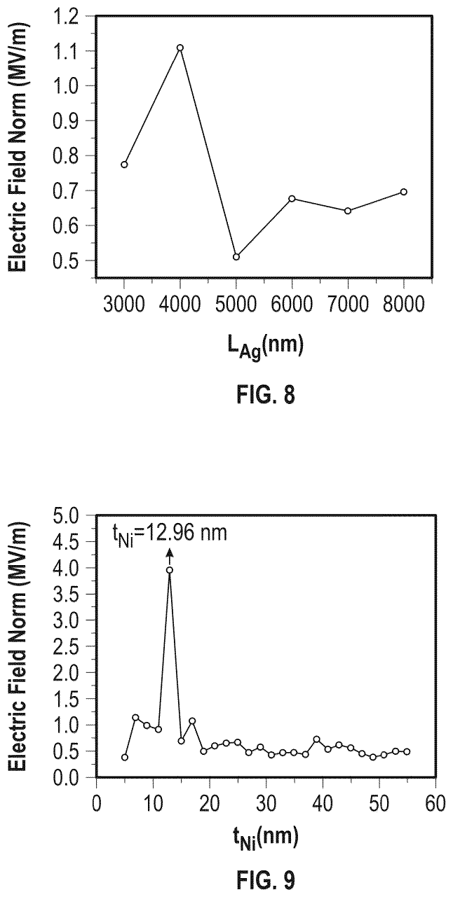

Referring to FIG. 4, three dimensional (3D) plot of the electric field norm /E/ and the position of hotspots along the length of a silver/nickel/nickel oxide nanowire is illustrated. These hotspots (see also the end-on view in FIG. 5) are due to plasmon coupling which allows for greater Raman signal amplification from the material of the nanowires themselves, thus allowing for greater return of Raman spectral signal from a sample that is attached to the nanowires. Referring to FIG. 6, another 3D plot of the electric field norm in a side view for a random array configuration of silver/nickel/nickel oxide nanowires, showing hotspot locations generated by the interaction between the array and electromagnetic radiation. Referring to FIG. 7, a graph of the electric field norm/as a function of the silver radius (rAg) is illustrated that shows that with a smaller radius, the electric field norm can be increased, particularly at 30 nm. Referring to FIG. 8, the graph illustrates the longitudinal electric field norm as a function of the length of the silver nanowire (LAg). As illustrated, shorter nanowires, particularly around 4000 nm, allow for increased electrical field norm. Referring to FIG. 9, a graph of the electric field norm as a function of the thickness of the nickel film (tNi) is illustrated which indicates a peak at 12.96 nm. These figures indicate that the dimensions of the silver/nickel/nickel oxide nanowires can be tuned to create the desired plasmonic effect and the desired degree of amplification. This is an additional process knob in addition to the alignment/orientation of the fibers which can be used for Raman signal amplification.

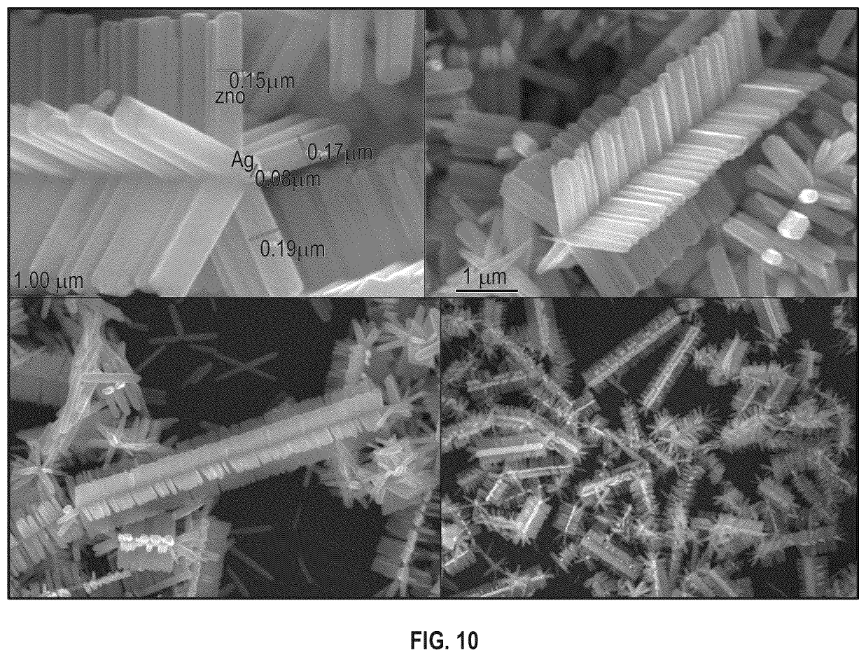

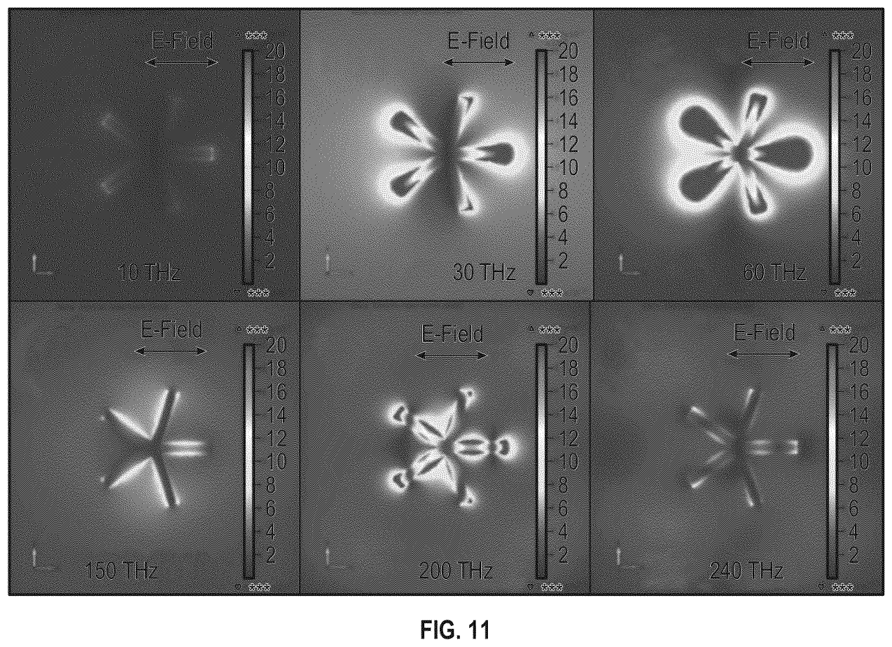

FIG. 10 depicts SEM images of the silver/zinc/oxide (Ag/ZnO) nanostructures formed as ZnO platelets grow in an ordered way onto the faces of an Ag nanowire a) front view of the structure in the center it is possible to see the silver nanowire forming pillar/column structures with dimensions in tenths and hundredths of nanometers. The image at the bottom right shows the arrangement of silver/zinc oxide structures as deposited on a substrate.

FIG. 11 illustrates various graphs of the simulation results from a calculation of the response of the Ag/ZnO nanostructures/nanorods at different frequencies after the application of an electrical field at different frequencies at 10 THz, 30 THZ, 60T HZ, 150 THz, 200 THz, and 240 THZ. These graphs illustrate that the amplification effect can also be adjusted by changes in the applied frequency to the nanostructures.

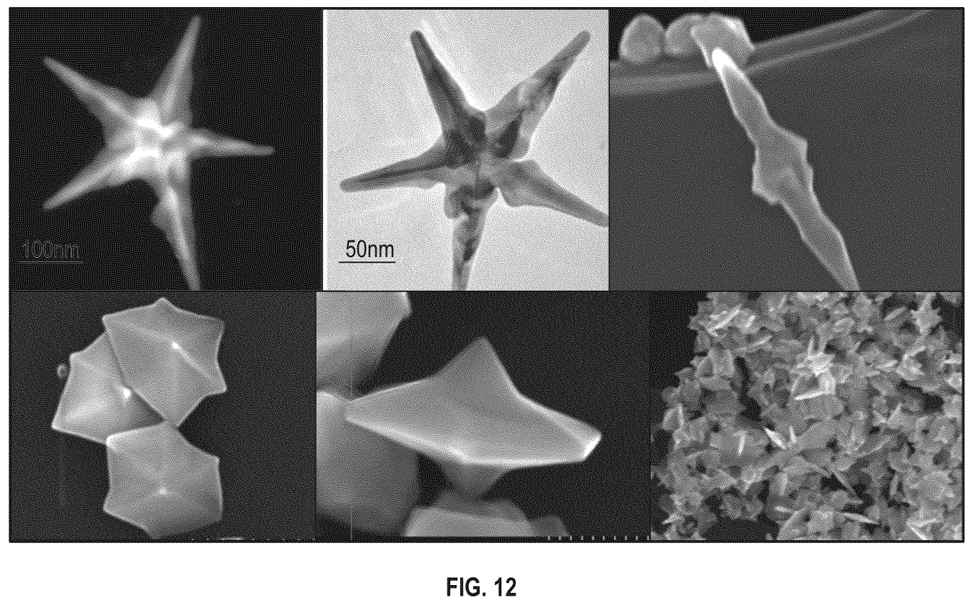

Referring to FIG. 12, various implementations of gold and gold/copper nanostars are illustrated, the shape of the nanostars can be controlled with the growth conditions. In various implementations, the shape of the nanostars is also a function of the amount of copper included as they are being formed. The presence of sharp facets in the nanostars increases the hotspots, which correspondingly enhances the signal. Thus for the nanostars, the ability to change the shape of the stars during growth is another process knob that can be adjusted to increase the amplification of the Raman signal. The bottom right image illustrates gold/copper nanostars deposited/formed on a substrate implementation.

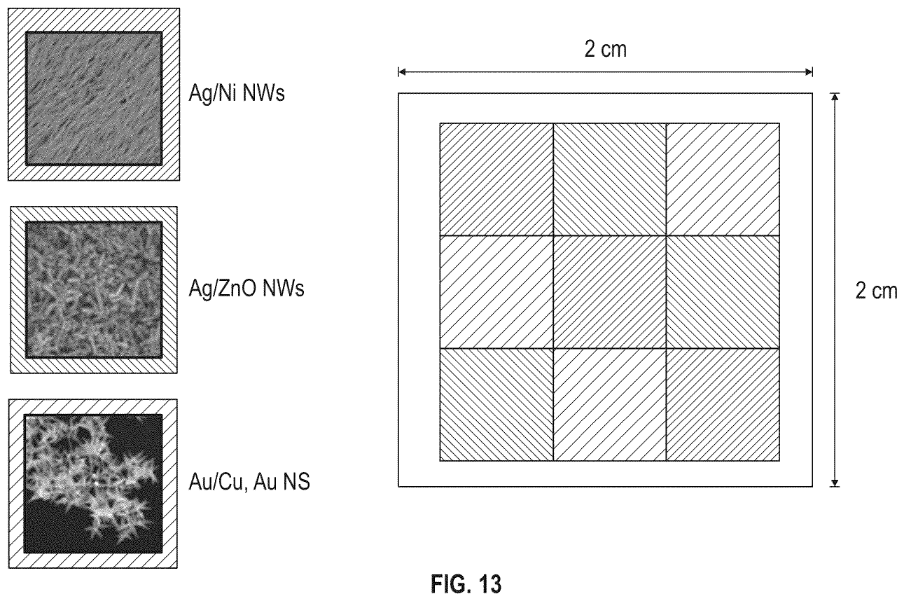

Referring to FIG. 13, is a top down view of an implementation of a substrate with regions of silver/nickel/nickel oxide nanowires, silver/zinc oxide nanostructures, and gold/copper and/or gold nanostars applied/formed/deposited thereon. As illustrated, this substrate contains an aluminum layer over a plastic base/core that forms 9 square regions. As illustrated, each square contains a particular one of the nanostructured materials. Each of the regions has a perimeter indicated by a line. In this implementation, the perimeters of each of the regions touch each other so they meet. This has the effect of ensuring there are no “dead spots” in the substrate surface where sample amplification cannot take place due to the lack of nanostructured material. The nanostructures form a dense 3D network that efficiently traps analyte molecules, enabling LOD<0.1 ppb. Magnetic capture plus high-surface-area geometry increases adsorption and signal uniformity. The hybrid design provides continuous plasmonic coverage from visible (SERS) to mid-IR. In particular implementations, the substrate is fabricated using optical lithography on a plastic with the surface covered with a thin layer of aluminum followed by adding the three complementary nanostructures. The aluminum does not give Raman signal and does not produce unwanted signals unlike filter paper or a polymer. In this implementation, the active area can be 3 cm² inches (though larger or smaller sizes may be utilized in other implementations) which nine squares placed in rows of three will contain the nanostructured material as illustrated in FIG. 13.

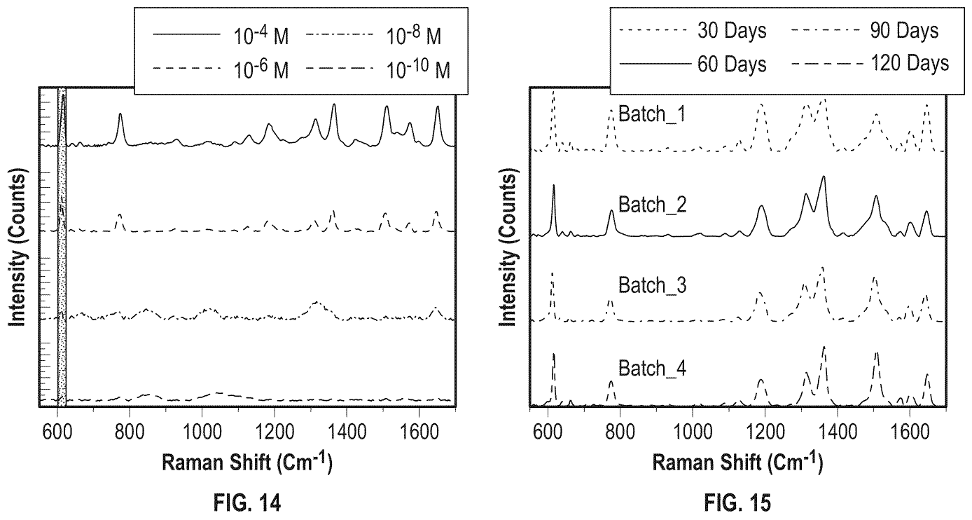

Referring to FIG. 14, a graph of SERS spectra of silver/nickel/nickel oxide wires where a sample of rhodamine 6G (R6G) has been deposited at varying concentrations of 10⁻⁴ molar (M), 10⁻⁶ M, 10⁻⁸ M, and 10⁻¹⁰ M deposited on a substrate implementation like that illustrated in FIG. 12. Referring to FIG. 15, a SERS spectra of silver/nickel/nickel oxide nanowires upon which R6G at 10⁻⁴ M measured every 30 days over a 120 day period is illustrated. As illustrated, because of the passivating effect of the nickel oxide on the silver nanowires, the ability to receive a consistent and detectable Raman spectral signal continues through the 120 day period, though the total intensity of each signal decreases linearly each 30 days.

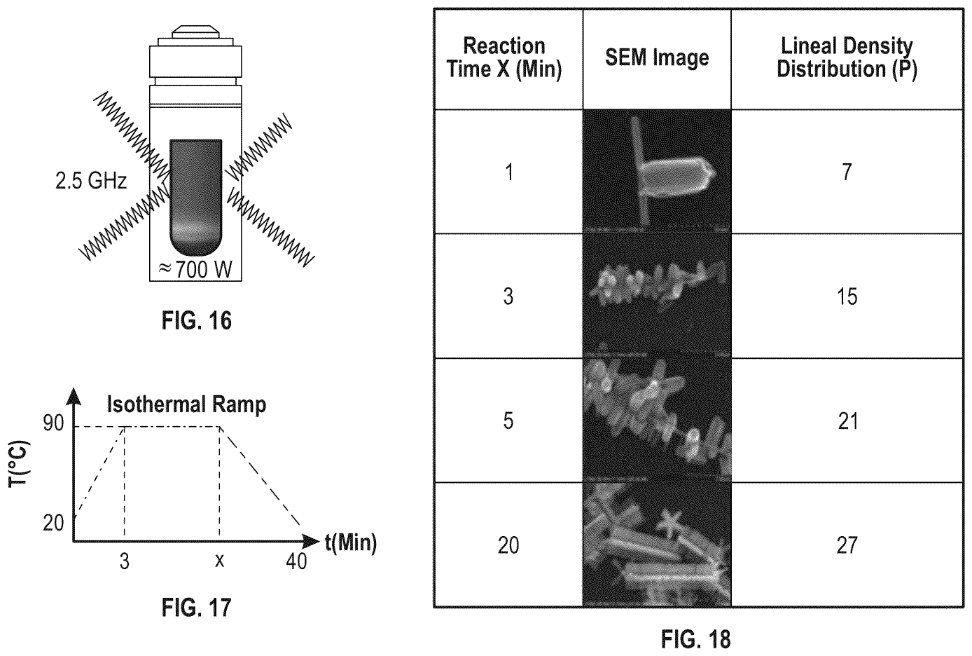

Referring to FIG. 16 illustrates a schematic representation of the microwave irradiation process used to form silver/zinc oxide nanostructures is illustrated. A vial containing the precursor solution is illustrated being irradiated with microwaves between 400 and 700 W at 2.5 GHz. FIG. 17 is a graph that shows the thermal ramp followed as a function of time for the different stages of growth. As illustrated, x can be varied from about 1 min to about 20 min to obtain the most stable/desired nanostructure. Referring to FIG. 18, the variation of the epitaxial distribution of silver/zinc oxide nanostructures/nanorods along the silver nanowires at different reaction times. The SEM images illustrate that an increase of about 7 to 27 in the linear density distribution P (number of ZnO rods/silver nanowire length) of the nanorods over time.

Described herein are hybrid nanostructured substrates that overcome reproducibility and stability limitations of conventional SERS systems. The platform integrates three complementary nanostructures on a single substrate which includes silver/nickel/nickel oxide nanowires, silver/zinc oxide nanostructures, and gold/copper and/or gold nanostars.

The various silver/nickel/nickel oxide nanowires disclosed herein have magnetic properties in which the Raman signal is enhanced by the localized surface plasmon (LSP) effect due to the silver and by the Ag/Ni-nickel interface which produces magneto-plasmon polaritons (MPP) effect. In addition, the magnetic character of the nanowires can promote the attachment of analytes/sample material to the substrate. The Ni/NiO interface also adds magneto-optic tuning, slightly shifting the plasmon frequency and improving stability. The structure of the nanowires as illustrated in FIGS. 1-3 forms a dense 3D conductive network that efficiently traps analyte molecules which can enable limit of detection (LOD)<0.1 ppb. Magnetic capture of the analyte plus high-surface-area geometry increases adsorption and signal uniformity. The presence of the various signal hot spots along the nanowires also assists with amplification. The combined effect of the surface plasmon polariton excitation in combination with the other properties of the silver/nickel/nickel oxide nanowires support Raman signal enhancement of up to about 10⁶-10⁸ times in the regions where the nanowires are located on the substrate. In various implementations, chemical enhancement effects due to charge transfer between the nickel/nickel oxide interface and the silver interface can result in additional Raman signal enhancement of about 10² times. Additional information regarding the structure, properties, behavior, and use of silver/nickel/nickel oxide nanowires can be found in the papers to Cedillo et al, entitled “Ag@Ni−NiO NW Core—Shell Nanowires: A Reliable Surface Enhanced Raman Scattering (SERS) Substrate,” Journal of Physical Chemistry C, V. 129, p. 4113-4125 (Feb. 17, 2025) https://doi.org/10.1021/acs.jpcc.4c08450; and the paper to Hernandez-Arteaga et al, entitled “Surface-enhanced Raman spectroscopy of Acetil-Neuraminic acid on silver nanoparticles: role of the passivating agent on the adsorption efficiency and amplification of the Raman signal,” The Journal of Physical Chemistry C, p. 1-51 (Aug. 31, 2017) DOI: 10.1021/acs.jpcc.7b07186, the disclosures of each of which are hereby incorporated entirely herein by reference.

The silver/zinc oxide nanomaterials/metamaterials illustrated in FIG. 18 are formed of ZnO platelets that are grown on the faces of a pentagonal nanowire. The ZnO platelets are arrayed in a periodic fashion along the five facets of the Ag nanowire. The Ag/ZnO is one of the best systems to produce surface plasmon polaritons (SPP) which is an important electric enhancement mechanism. The strong field confinement enhances the signal from the visible to the near infrared. The radiation pattern of the Ag/ZnO metastructures produce hot spots in which the Raman signal is amplified. The hot spots are shown in FIG. 11, which is a calculation using the software marketed under the tradename COMSOL by COMSOL, Inc. of Burlington, Massachusetts at various frequencies as previously discussed.

The location and symmetry of the hot spots indicates that the metastructures are an optimum system for SPP enhancement as it can enhance in five different directions separated by angles of 72 degrees which results in 360 degree coverage for each individual nanostructure. Additionally, the 3-D arrangement of the metastructures results in a very high cross section for the capture of the analyte molecules. In various silver/zinc oxide nanostructure implementations, the Raman signal enhancement through SPPs is about 10⁶-10⁸ times. In addition, there is an increased enhancement due to charge transfer (chemical mechanism) that occurs at the ZnO-metal-molecule interface, further improving Raman sensitivity through resonant electron transfer. This chemical enhancement can provide Raman signal enhancement of about 10² times. Additional information regarding the performance, formation, and use of the silver/zinc oxide nanostructures can be found in the papers to: Sanchez et al., entitled “Electric radiation mapping of silver/zinc oxide nanoantennas by using electron holography,” Journal of Applied Physics, V. 117, 034306, (Jan. 16, 2015) http://dx.doi.org/10.1063/1.4906102; the paper to Sanchez et al., entitled “Silver/zinc oxide self-assembled nanostructured bolometer,” Infrared Physics & Technology, V. 81, p. 266-270 (Jan. 25, 2017) http://dx.doi.org/10.1016/j.infrared.2017.01.019; and the paper to Sanchez et al., entitled “Structural analysis of the epitaxial interface Ag/ZnO in hierarchical nanoantennas,” Applied Physics Letter, V. 109, p. 153104 (Oct. 10, 2016) http://dx.doi.org/10.1063/1.4964719, the disclosures of each of which are hereby incorporated entirely herein by reference.

A combination of AuCu and Au nanostars (a mixture of which are illustrated in FIG. 12) provides strong localized plasmon resonance (LSPR) through the long plasmonic arms extending activity into the infrared, complementing visible-range SERS. Various implementations where nanostars are used may see whether the electromagnetic field also couples to this magneto-optic response, producing magneto-plasmon polaritons (MPP) which also enhance the signal excitations. Au sustains plasmonic oscillation even into the near infrared. The Cu amount on the alloy determines the shape of the nanostars from long to short arms. In various implementations, the gold/copper and/or gold nanostars may support localized surface plasmon resonance that produces Raman signal enhancement of 10⁶-10⁸ times. Additional information regarding the structure, formation, and properties of gold and gold/copper nanostars may be found in the paper to Velasquez-Salazar et al, entitled “Controlled overgrowth of five-fold concave nanoparticles into plasmonic nanostars and their single-particle scattering properties,” ACS Nano, V. 13, p. 10113-10128 (Aug. 15, 2019) DOI: 10.1021/acsnano.9b03084, the disclosure of which hereby incorporated entirely herein by reference.

In various system and method implementations disclosed herein, the silver/nickel/nickel oxide nanowires can be prepared using any of the methods disclosed herein including the various papers incorporated by reference. In a non-limiting example, silver/nickel/nickel oxide nanowires were synthesized using a two-step polyol reduction method. In a reaction vessel, 36 mL of 0.3 M polyvinylpyrrolidone (PVP) and 80 μL of 0.2 M sodium chloride (NaCl) were combined and heated to 160 C. To this was added 1 M silver nitrate (AgNO₃, 80 μL), and then, after 5 min, a further charge of 1 M AgNO 3 (4 mL) was slowly added; when the color of the solution turned to a hazy auburn, the residual AgNO₃ solution was added into the vessel immediately. After 30 minutes, the silver nanowires in their initial state were centrifuged three times with ethanol, with each wash cycle lasting five minutes at 2500 rpm. The purified silver nanowires had lengths of 10-15 μm and diameters of 60-110 nm. The prepared silver nanowires were then stored in an aqueous solution (stock solution) containing polyvinylpyrrolidone (PVP, 1 wt %) and diethylhydroxylamine (DEHA, 1 wt %). The nanowires were cleaned, and the surfactant was removed.

Silver nanowires with nickel coating were synthesized by adding the silver nanowire stock solution (0.732 mL) to a 20 mL scintillation vial containing a solution (1.32 mL) of PVP (2 wt %) in ethylene glycol (EG), a given amount of a solution containing Ni(NO₃)₂·6H₂O (0.1 M) in water (157 μL, 54% Ni) for nanowires, and hydrazine (132μL, 35 wt %). This mixture was vortexed for 15 seconds and heated at 120 C for 10 min without stirring. During the heating step, the silver nanowires aggregated and floated to the top of the solution. As the Ni reduced on the silver nanowires, they became darker in color. After 10 minutes, the as-prepared silver/nickel were washed three times with deionized water through centrifugation; each wash cycle took 5 minutes at 2500 rpm. The oxidation of the Ni is produced spontaneously as it reacts with ambient oxygen in the air. At the end, the structure was a silver/nickel/nickel oxide.

The silver/zinc oxide nanostructures disclosed herein may be prepared using any method disclosed herein including in the papers incorporated herein by reference. In a particular non-limiting implementation, the Ag/ZnO metal-semiconductor nanostructure system can be synthesized by establishing a two-step process. First, silver nanowires were fabricated by following the polyol method: 5 ml of ethylene glycol (EG) were heated at 160 C for 40 min; next, a silver nitrate AgNO₃ (reagent grade 99.99% by Sigma-Aldrich) is reduced in a solution of EG following the addition of polyvinyl pyrrolidone (PVP, Mw 55,000 reagent grade 99.99% by Sigma-Aldrich); (EG) and (PVP) act as reducer solution and capping agent to polar molecules, respectively; the mixture is subjected to a constant stirring rate for a period time, 40 to 60 min, until the silver nanowires reach the desired and most stable diameter (˜70 nm) and length (more than 2 μm). After formation of the silver nanowires, the self-assembling process of ZnO nanorods on silver nanowires was carried out to reproduce a metal-semiconductor (Ag/ZnO) heterojunctions. In a particular implementation, the method included dissolving zinc acetate dihydrate (Zn(Ac)₂, 98% reagent by Sigma-Aldrich), 5-25 mM and hexamethylenetetramine (HMT) 5-25 mM in deionized water to form a precursor initial solution; next, 200 μl of silver nanowires, as obtained by the polyol method, were added to the former solution, which is now irradiated using an ETHOS EZ Microwave Digestion System, working within 400 to 700 W at a microwave frequency of 2.5 GHz; FIG. 16 shows a schematic representation of the MIP process just described. The vial containing the precursor solution is heated between 20 C-90 C, with an exposure reaction time from 1 to 50 min; the thermal ramp for the microwave process is shown in FIG. 17 as a function of the reaction time. The second column in FIG. 18 reveals the time dependent morphological features on Ag/ZnO system as the reaction proceeds.

In various system and method implementations, the synthesis of gold and gold/copper nanostars may be carried out using any method disclosed in this document, including those in the papers incorporated by reference herein. In a particular non-limiting implementation, the method includes preparing a growth solution in a 20 mL glass vial at room temperature, by adding 600 μL of CuCl₂ (100 mM in ethanol) and 200 μL of HAuCl₄ (100 mM in ethanol) to 7 mL of OLA. Subsequently, 400 μL of freshly prepared CPNPs were added to the mixture (these particles were produced the same day). The solution was heated at 120 C for 30 min and then cooled at room temperature. The color of the solution at this last step was brown/green. To follow the growth evolution of gold/copper nanostars, aliquots were taken from the solution in 10 min intervals during the reaction. The gold/copper nanostars were further purified by centrifuging several times with ethanol and finally redispersed in chloroform for further characterization.

The various substrate implementations disclosed herein provide Raman signal enhancement in up to three different ways using three types of amplification: a) amplification of electromagnetic fields (EM) b) chemical enhancement and c) magnetic enhancement. EM amplification takes place when laser light hits the sample on the substrate, the interfaces of Ag/Ni/NiO nanowires and Ag/ZnO nanostructures support excitation called a Surface Plasmon Polariton (SPP). The propagation of the SPP along the x-axis is characterized by a transverse-magnetic (TM) or p polarization and is associated with a surface charge density fluctuation. The propagation of the SPP in the nanorods or the nanostructures produces a Raman signal enhancement of up to about 10⁶-10⁸ times.

For chemical enhancement, the Ag/ZnO nanostructures and the Ni-NiO interfaces in the silver/nickel/nickel oxide nanostructures induce chemical enhancement (CM). This primarily involves charge transfer mechanisms, where the excitation wavelength is resonant with the metal-molecule charge transfer electronic states. This mechanism produces a signal enhancement of about 10² times.

The Ag/Ni/NiO nanowires are magnetic and this property enables further enhancement of the Raman signal by the effect of magnetic fields (magnetoplasmonics, the field investigating materials that integrate magnetic properties with plasmonic resonances). The magnetoplasmonic effect can produce an additional enhancement of the Raman signal of 10²-10³ times.

In addition to the foregoing, the Ag and Au nanostructures produce Localized Surface Plasmon Resonance (LSPR), which forms non-propagating plasmon excitations and can be directly excited by free space. This produces an enhancement similar at the one produced by SPP, or a Raman signal enhancement of up to about 10⁶-10⁸ times.

In various substrate implementations, these enhancement effects are combined due to the use of the three different nanostructured materials to create a substrate that has a total amplification of the SERS and SEIRA signals of 10¹²-10¹⁴ times. This means that the substrate has a detection limit of 10-14 M which approaches the single molecule detection threshold.

In various implementations, the substrate is corrosion resistant, and a shelf life of about two years or more. The substrate implementations, due to the different nanostructured materials included, can also amplify signals in a wide range of frequencies from the visible to the mid-infrared. Different nanostructures will act in different frequencies of the spectrum. The Ag/Ni/NiO, Ag/ZnO, and Au/Cu can also resist mechanical abrasion when rubbing against smooth and rough surfaces.

The various substrate implementations disclosed herein may be constructed using implementations of a method of forming a substrate for use in Raman spectroscopy. The method may include providing a plastic substrate with a largest planar surface and forming a layer of aluminum on the largest planar surface. The method then includes forming a first patterned layer on the layer of aluminum. In various method implementations this may be carried out using various lithographic methods (photolithography, aligners, etc.) or may be carried out using a stencil printing or screen printing method in other implementations. The method then includes applying silver/nickel/nickel oxide nanowires to one or more exposed portions of the layer of aluminum to form one or more defined first regions. The application of the nanowires in this part of the process may be carried out using any method disclosed in this document. The method also includes removing the first patterned layer using a method consistent with the material of the patterned layer and which will not damage the silver/nickel/nickel oxide nanowires (solvent stripping, washing, ashing, etc.). The method includes forming a second patterned layer on the layer of aluminum using any the methods disclosed herein and applying gold/copper and/or gold nanostars to one or more exposed portions of the layer of aluminum to form one or more defined second regions. The method includes removing the second pattered layer using any method disclosed herein and forming a third patterned layer on the layer of aluminum using any method disclosed herein. The method also includes applying silver/zinc oxide nanostructures to one or more exposed portions of the layer of aluminum to form one or more defined third regions.

In various method implementations, the various regions contact each other along a perimeter of each region (as in the implementation illustrated in FIG. 13). The method also may include preventing corrosion of the silver/nickel/nickel oxide nanowires through applying nickel to the silver nanowires and allowing native nickel oxide to form. The method also includes preventing corrosion of the silver/zinc oxide nanostructures through forming the zinc oxide onto the silver nanowires. The method may also include altering a start shape of the gold/copper nanostars through altering an amount of copper included in the gold/copper nanostars.

In various implementations, the substrates formed according to the methods disclosed herein are utilized in a Raman spectroscopic system. This system may be a portable dual-mode Raman/IR system that includes a compact instrument that incorporates a quantum cascade laser source for infrared and a visible light Raman source (wavelengths between about 532 nm to 785 nm) with corresponding optical components. A charge coupled detector is then used to observe a substrate treated with the analyze during spectroscopic analysis by either light source. As both light sources can be used, simultaneously Raman and SEIRA detection within a single portable device can be achieved.

In places where the description above refers to particular implementations of substrates for use in Raman spectroscopy and implementing components, sub-components, methods and sub-methods, it should be readily apparent that a number of modifications may be made without departing from the spirit thereof and that these implementations, implementing components, sub-components, methods and sub-methods may be applied to other substrates for use in Raman spectroscopy.

What is claimed is:

1. A substrate for use in Raman spectroscopy comprising:
a first largest planar surface separated from a second largest planar surface by a thickness, the thickness comprising a plastic material;
a layer of aluminum coupled on the first largest planar surface;
one or more first defined regions of silver/nickel/nickel oxide nanowires coupled to the layer of aluminum;
one or more second defined regions of gold/copper and gold nanostars coupled to the layer of aluminum; and
one or more third defined regions of silver/zinc oxide nanostructures coupled to the layer of aluminum.

2. The substrate of claim 1, wherein the one or more first defined regions, one or more second defined regions, and one or more third defined regions are physically separate from each other on the layer of aluminum.

3. The substrate of claim 1, wherein the one or more first defined regions, one or more second defined regions, and one or more third defined regions contact one another along a perimeter of each region.

4. The substrate of claim 1, wherein the silver/nickel/nickel oxide nanowires and the silver/zinc oxide nanostructures support surface plasmon polariton excitation that produces Raman signal enhancement of 10⁶-10⁸ times.

5. The substrate of claim 1, wherein the silver/zinc oxide nanostructures and the silver/nickel/nickel oxide nanowires induce chemical enhancement that produces Raman signal enhancement of 10² times.

6. The substrate of claim 1, wherein the silver/nickel/nickel oxide nanowires induce magnetoplasmonic enhancement that produces Raman signal enhancement of 10²-10³ times.

7. The substrate of claim 1, wherein the gold/copper and gold nanostars support localized surface plasmon resonance that produces Raman signal enhancement of 10⁶-10⁸ times.

8. The substrate of claim 1, wherein the substrate provides surface-enhanced Raman scattering enhancement of 10¹²-10¹⁴ times and surface enhanced infrared absorption spectroscopy enhancement of 10¹²-10¹⁴.

9. The substrate of claim 1, wherein the substrate has surface-enhanced Raman scattering detection of up to 10⁻¹⁴ molar and surface enhanced infrared absorption spectroscopy detection of up to 10⁻¹⁴ molar.

10. The substrate of claim 1, wherein the one or more first defined regions, one or more second defined regions, and one or more third defined regions are each mechanical abrasion resistant.

11. The substrate of claim 1, wherein the one or more first defined regions, one or more second defined regions, and one or more third defined regions are configured to receive a sample thereon.

12. The substrate of claim 1, wherein the substrate is corrosion resistant with a shelf life of up to two years.

13. The substrate of claim 1, wherein the substrate is corrosion resistant with a shelf life of two years or greater.

14. The substrate of claim 1, wherein the nickel and nickel oxide prevent corrosion of the silver/nickel/nickel oxide nanowires.

15. The substrate of claim 1, wherein the zinc oxide prevents corrosion of the silver/zinc oxide nanostructures.

16. A method of forming a substrate for use in Raman spectroscopy, the method comprising:
providing a plastic substrate with a first largest planar surface;
forming a layer of aluminum on the first largest planar surface;
forming a first patterned layer on the layer of aluminum;
applying silver/nickel/nickel oxide nanowires to one or more exposed portions of the layer of aluminum to form one or more defined first regions;
removing the first patterned layer;
forming a second patterned layer on the layer of aluminum;
applying gold/copper and gold nanostars to one or more exposed portions of the layer of aluminum to form one or more defined second regions;
removing the second patterned layer;
forming a third patterned layer on the layer of aluminum; and
applying silver/zinc oxide nanostructures to one or more exposed portions of the layer of aluminum to form one or more defined third regions.

17. The method of claim 16, wherein the one or more first defined regions, one or more second defined regions, and one or more third defined regions contact one another along a perimeter of each region.

18. The method of claim 16, further comprising preventing corrosion of the silver/nickel/nickel oxide nanowires through applying nickel to silver nanowires and allowing native nickel oxide to form.

19. The method of claim 16, further comprising preventing corrosion of the silver/zinc oxide nanostructures through forming zinc oxide on silver nanowires.

20. The method of claim 16, further comprising altering a star shape of the gold/copper nanostars through altering a composition of copper included in the gold/copper nanostars.
